(19) United States
(12) Patent Application Publication
(10) Pub. No.: US 2002/0145267 A1
(43) Pub. Date: Oct. 10, 2002

(54) Hydraulically operated gooseneck and method of operating same

(75) Inventor: Edwin L. Boon, Surrey (CA)

Correspondence Address: John Russell Uren, P. Eng., 1590 Bellevue Avenue - Suite 202, West Vancouver, BC, V7V 1A7, CA

(73) Assignee: K-LINE TRAILERS LTD.

(21) Appl. No.: 09/828,458

(22) Filed: Apr. 5, 2001

(51) Int. Cl. B62D 53/06

(52) U.S. Cl. 280/441.2; 280/402

(57) ABSTRACT

A gooseneck associated with a lowbed trailer. The gooseneck is hydraulically operated. Hydraulic cylinders are mounted within box beams which make up the gooseneck and are located a distance apart. The hydraulic cylinders act on a linkage assembly which linkage assembly is connected to and acts upon a push frame. The push frame interacts with the lowbed trailer thereby to raise or lower the lowbed trailer upon operation of the hydraulic cylinders. An auto steer dolly is conveniently connected to the gooseneck or directly under a long load.

### INTRODUCTION

This invention relates to a gooseneck used on lowbed trailer assemblies in heavy load trucking operations and, more particularly, to a hydraulically operated gooseneck used for raising and lowering a lowbed trailer. This invention further relates to an auto steer dolly conveniently connected to the gooseneck or directly under a long load.

### BACKGROUND OF THE INVENTION

Goosenecks are used in trucking operations to enable the lowbed with which they are associated to be raised or lowered relative to a fifth wheel associated with a tractor, a jeep or another low bed. The purpose of such goosenecks in the raising or lowering operations is to allow the load such as self propelled machinery or the like to be more easily loaded on or unloaded from the lowbed with which the gooseneck is associated and to allow the height of the lowbed to be adjusted. The gooseneck is also used to connect to or disconnect from a fifth wheel associated with a further vehicle. The use of goosenecks in such operations is well known.

Earlier prior art goosenecks used a cylinder connected to the gooseneck and pushed on the ground from the frame of the gooseneck. This raising or lowering action, however, involves large weights. Various support plates and other apparatuses were used in order to prevent the penetration of the ground surface by the cylinder. This was inconvenient and time consuming. Other hydraulically operated goosenecks are so called “frame acting” goosenecks. Such goosenecks use hydraulic cylinders connected between the gooseneck and an attached push frame rotatably attached to and associated with the gooseneck. The push frame then pushes on the deck of the loaded trailer and this force interaction raises or lowers the gooseneck. To raise a low bed following loading, for example, the gooseneck would be placed in position on the fifth wheel and the hydraulic cylinders would apply force between the push frame and against the lowbed trailer. This force interaction in turn transfers force onto the fifth wheel thereby lifting the frame of the lowbed trailer. Alternatively, the push frame may be used to lower the frame of the lowbed trailer when vehicle unloading is desired.

Such earlier frame type hydraulically operated goosenecks have disadvantages. Because the hydraulic cylinders act directly on the push frame, more vertical positioning of the cylinders is desirable and, therefore, significant vertical volume for the gooseneck is dictated. It is desirable to keep the vertical distance of the gooseneck to a minimum since the lower the center of gravity, the more stable the loading on the lowbed trailer. Further, since utility lines, overpasses, tunnels and the like all offer vertical limitations and, therefore, movement restrictions to the load on the lowbed, it is desirable to keep the vertical profile of the gooseneck and trailer as low as possible so that the payload height is similarly lower. A further disadvantage is that the gooseneck of the prior art comprises two gooseneck beams mounted a distance apart. Prior art hydraulics for earlier goosenecks are generally mounted between such beams and this does not allow efficient use of the space between the gooseneck beams. It would be desirable if such space could be used by the operator of the lowbed for load stowage operations, such as allowing the carrying of portions of the load such as hinged excavator booms and the like.

Automatic steering mechanisms for trailers used in the transport of heavy loads are well known in the transportation art. Such auto steer mechanisms allow a trailer to negotiate corners and turns despite the significant length of the trailer on which the load is carried. Such an auto steer mechanism is disclosed and illustrated in Murray et al U.S. Pat. No. 4,484,758. The auto steer mechanism there described utilises a deck connected beneath a gooseneck, the deck having a steering dolly mounted thereunder. The steering dolly utilises an A-frame which is connected to a steering arm at the forward end and which is connected to an equaliser link at its rearward end. The steering arm is adjustable to increase or decrease the degree of steering provided and the equaliser compensates for the changes of length in the equaliser arm during the auto steer.

While this device works satisfactorily in respect of the auto steer function, the equaliser, the steering arm and the A-frame are all mounted above the dolly. The above-dolly location utilises space which could otherwise be used for transport purposes and unnecessarily requires additional vertical distance which is disadvantageous with height limited overpasses and the like under which the trailer must pass. Likewise, if it is intended to convert the steering function from mechanical to hydraulic with input from the operator for the latter, the disconnect and subsequent setup processes are complicated and unnecessarily time consuming.

### SUMMARY OF THE INVENTION

According to one aspect of the invention, there is provided a hydraulically operated gooseneck for use with a lowbed trailer comprising at least one hydraulic cylinder within a beam of said gooseneck, said hydraulic cylinder applying force to a pushframe through a linkage applying force to said pushframe, said linkage applying a directional force to said pushframe which directional force is offset from the axis of said hydraulic cylinder acting on said linkage.

According to a further aspect of the invention, there is provided a method of moving a gooseneck relative to the fifth wheel of a tractor or jeep comprising the steps of applying a force from a hydraulic cylinder mounted within a beam of said gooseneck to a linkage connected to a push frame associated with a lowbed trailer, said force being sufficient to move said beam of said gooseneck relative to said push frame and thereby raising or lowering said lowbed trailer, the direction of axial force applied from said hydraulic cylinder being offset from the direction of force applied to said push frame from said linkage during said raising or lowering.

According to still yet a further aspect of the invention, there is provided an auto steer mechanism for steering a second set of wheels mounted beneath a dolly frame which is rotatable about a vertical axis comprising a first set of wheels having a first axis of rotation on one side of said vertical axis, said distance between said first axis and said vertical axis being constant, a second set of wheels having a second axis of rotation on the opposite side of said vertical axis, said second set of wheels being positioned on a wheel frame which is rotatable about said second axis of rotation, said wheel frame having a frame pivot point, a stinger adjustably mounted to rotate about said vertical axis and having a stinger pivot point, at least one equaliser link mounted between said frame and stinger pivot points, the distance between said stinger pivot point and said vertical axis being adjustable, said rotatable frame, said stinger and said equaliser link being located beneath said dolly frame.

According to yet a further aspect of the invention, there is provided a method for steering a set of wheels about a vertical frame axis which wheels are mounted on a wheel frame having a frame pivot, said wheel frame being positioned beneath and rotatable relative to a dolly frame comprising the steps of allowing said wheel frame to rotate relative to said dolly frame about said vertical wheel frame axis during movement of said dolly frame relative to the rotation of said wheel frame, allowing an adjustable stinger having a stinger pivot to rotate relative to said dolly frame and allowing at least one equaliser link extending between said frame and stinger pivots to extend and contract as said wheel frame rotates relative to said dolly frame.

### BRIEF DESCRIPTION OF THE SEVERAL VIEWS OF THE DRAWINGS

Specific embodiments of the invention will now be described, by way of example only, with the use of drawings in which:

FIG. 1A is a diagrammatic side view illustrating a transporter assembly and particularly illustrating the gooseneck according to the invention on the lowbed trailer used for carrying the load in the transport condition;

FIG. 1B is a diagrammatic plan view similar to FIG. 1A but omitting the tractor and the initial jeep connected to the tractor shown in FIG. 1A;

FIG. 2 is a diagrammatic side view similar to FIG. 1 but illustrating the lowbed trailer in its fully raised position and deleting the second jeep, the push bar and the push truck of FIG. 1A;

FIGS. 3A, 3B and 3C are side diagrammatic and enlarged views illustrating the gooseneck and its associated pushframe according to the invention in positions where the lowbed assembly with which the gooseneck is associated is in the fully lowered, the transport and the fully raised positions, respectively;

FIG. 4 is a plan view of the gooseneck particularly illustrating the two(2) box beams according to the invention together with the enclosed hydraulic cylinders;

FIG. 5 is a diagrammatic sectional view taken along V-V of FIG. 4;

FIG. 6 is a view similar to FIG. 3B but illustrating the push frame in contact with the frame of the lowbed trailer with the gooseneck in its transport position;

FIG. 7A is a diagrammatic side view of a dolly particularly illustrating the lower mounted adjustable stinger and equaliser links according to the invention;

FIG. 7B is a diagrammatic plan view of the dolly similar to FIG. 7A but which particularly illustrates the stinger or steering arm mounted beneath the dolly frame axis and the stinger pivot point which is connected to the wheel frame;

FIG. 7C is a side view of an equaliser link in its exten ded position;

FIG. 7D is a diagrammatic plan view of the rear wheel frame which is similar to FIG. 7B but particularly illustrating the rear wheel frame in its rotated position relative to the dolly; and

FIG. 8 is a diagrammatic side view of the dolly similar to FIG. 7A but also illustrating the hydraulic cylinder used for steering the wheel frame at low speeds of the transport in a further and modified embodiment according to the invention.

### DESCRIPTION OF SPECIFIC EMBODIMENT

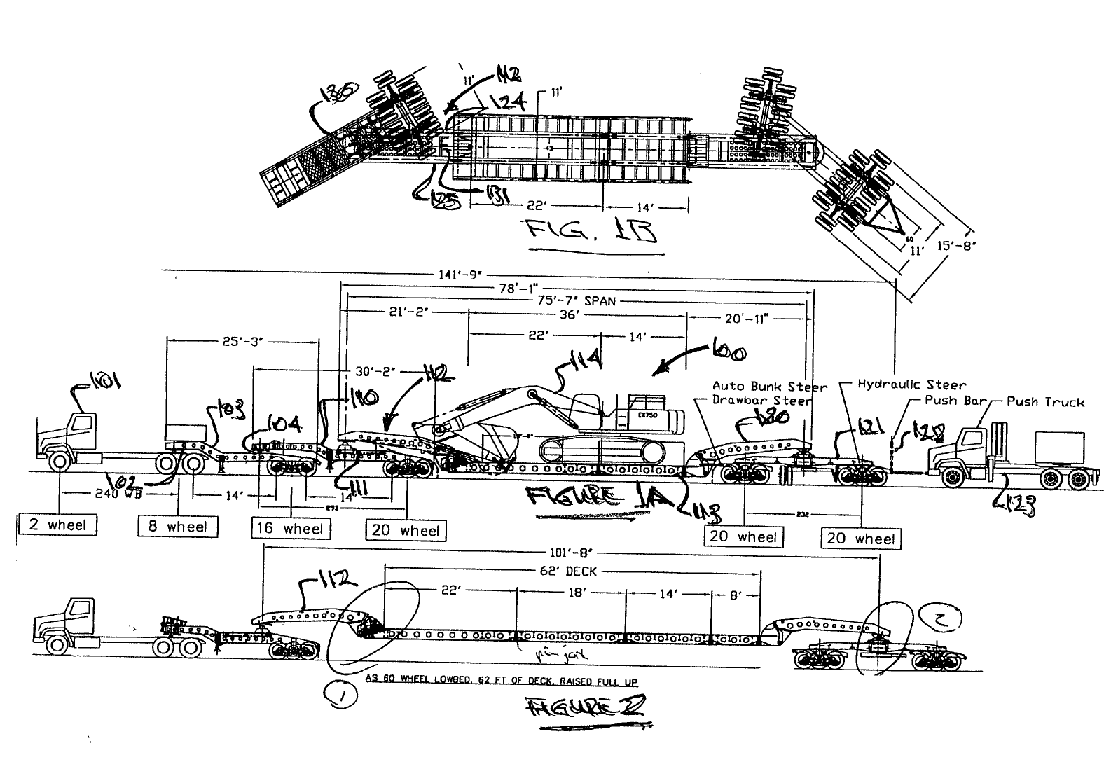

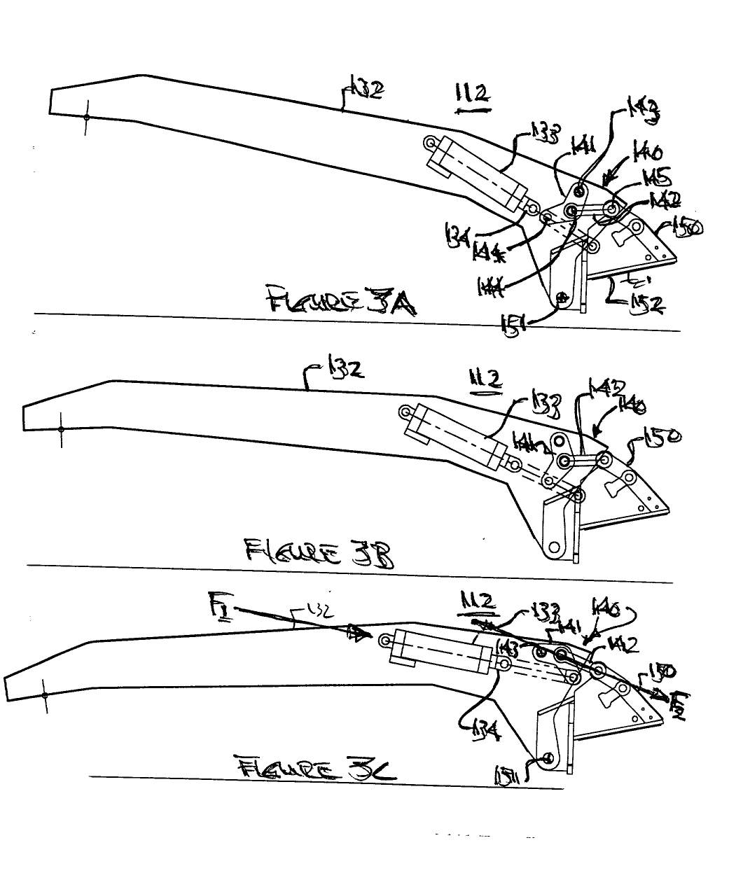

Referring now to the drawings, a transporter assembly is generally illustrated at 100 in FIG. 1A. The transporter assembly 100 comprises a tractor 101 with an attached and first fifth wheel 102. A first jeep 103 is connected to the fifth wheel 102 and further includes a second fifth wheel 104. A second jeep 110 is connected to second fifth wheel 104 and has an attached third fifth wheel 111.

The gooseneck according to the invention is generally illustrated at 112. It is connected to a lowbed trailer 113 which is used for carrying the desired load, in this instance an excavator 114. A second gooseneck 120 extends from the end of the lowbed trailer 113 and is connected to a dolly 121, in this instance an automatic steerable dolly 121 as will be further described. A push bar 122 is mounted on the rear of steerable dolly 121 and a push truck 123 may act on the push bar 122. The low bed trailer 113 is illustrated in its transport position in FIG. 1A.

The gooseneck 112 (FIG. 4) comprises two gooseneck beams 124, 125. The gooseneck beams 124, 125 are interconnected at the forward end and the interconnection 130 is positioned above and attached to the third fifth wheel 111 as described. It will be seen there is significant space 131 between the gooseneck beams 124, 125 extending from the point of attachment of the gooseneck 112 to the lowbed trailer 113 to the interconnection 130 on the forward end of the gooseneck 112.

The two(2) box beams 124, 125 of gooseneck 112 each allows a respective hydraulic cylinder 133 to be mounted within the respective box beam 124, 125. The hydraulic cylinders 133 are of appropriate capacity for the required loading of the lowbed trailer 113.

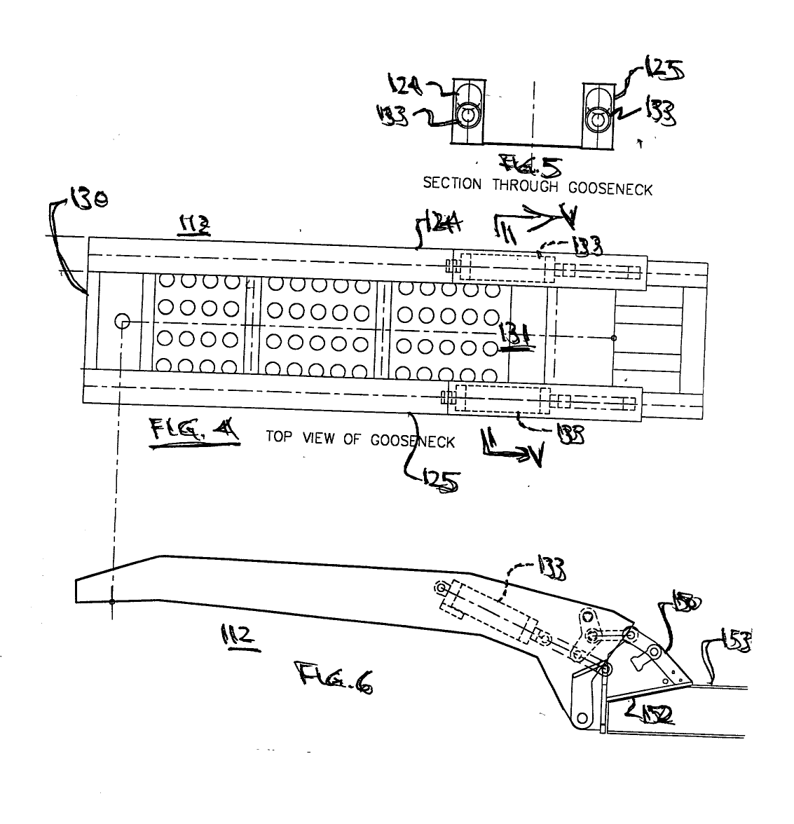

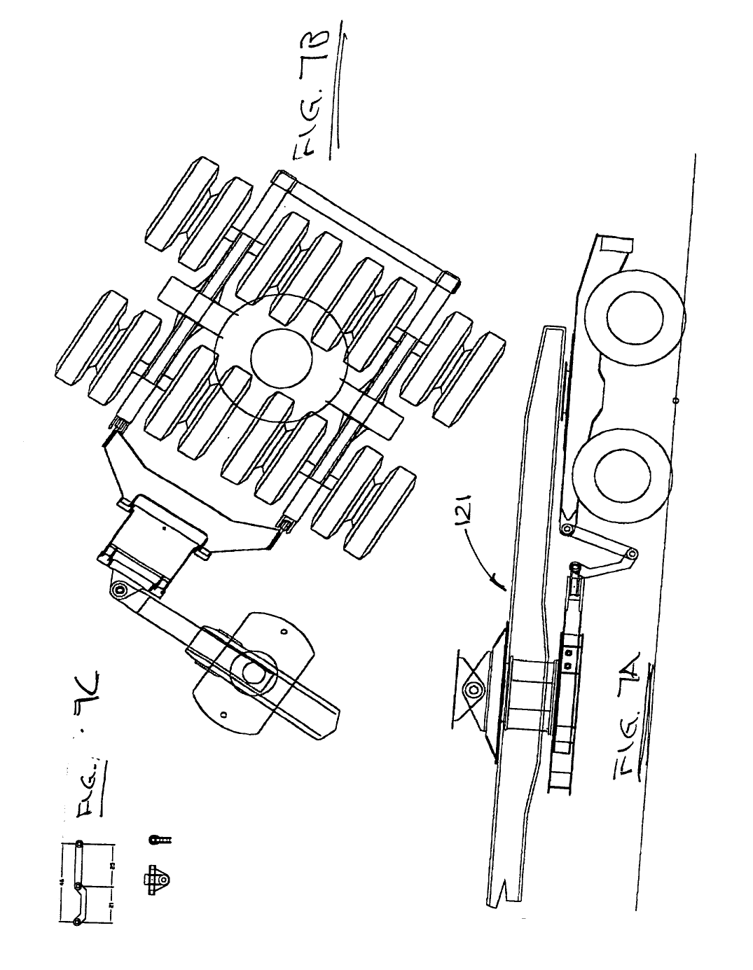

The pistons 134 of the hydraulic cylinder 133 are connected to a linkage generally illustrated at 140 (FIG. 3A). Linkage 140 has two links 141, 142. Link 141 rotates about axis 143 and is pivotally connected to piston 134 as illustrated. Link 142 rotates about axes 144 and is connected to link 141 about axis 144. Link 142 is further pivotally connected to push frame 150 and rotates abut axis 145. It provides the application of force to the push frame 150 which rotates about axis 151. Axis 151 takes the form of a pin connection which is mounted on the frame 153 (FIG. 6) of the lowbed trailer 113 as will be described.

### Operation

In operation, it will be appreciated that heavy haul industries, to which the present invention relates, are subject to myriad federal, state and provincial regulations and statutes covering a multitude of public concerns including vehicle and road loading and dimensions. It is therefore necessary to be flexible in designing load hauling vehicles. Accordingly, FIG. 1A illustrates only one of many different configurations that may be used for the specific load intended to be transported.

It will be assumed initially that the lowbed trailer 113 of FIG. 1A, shown in the transport position, is to be fully lowered such that the excavator 114 may be unloaded from or loaded on the lowbed trailer 113. In such event, the hydraulic cylinder 133 (FIG. 3B) shown in the transport position identical to that in FIG. 1A will be retracted such that piston 134 moves inwardly relative to hydraulic cylinder 133. Such retraction will rotate link 141 clockwise about axis 143. Link 142 will follow link 141 and push frame 150 will rotate counterclockwise about axis 151.

Push frame 150 is acting directly on the frame 153 of lowbed 113 through interface 152 (as best seen in FIG. 6) and since the interconnection 130 joining the box beams 124, 125 (FIG. 4) of gooseneck 112 is in contact with fifth wheel 111 (FIG. 1A), the forward portion of the lowbed trailer 113 will be lowered until the lowermost position of the gooseneck 112 is achieved as illustrated in FIG. 3A such that the excavator 114 may be more easily removed from the lowbed trailer 113. If the excavator 114 is being loaded onto the lowbed trailer 113, the same position for the gooseneck 112 would be used until the lowbed trailer is loaded 113. After loading, the operation described is repeated in reverse until the transport position of the lowbed trailer 113 is achieved wherein transport may be initiated.

Due to the length of the lowbed trailer 113, it may often be necessary to increase the ground clearance of the lowbed trailer 113 during transport such as when an elevated railway crossing or other ground terrain problem is present. In such case and with reference to FIG. 3C, the hydraulic cylinder 133 is activated and the piston 134 is extended to its fully extended condition as illustrated. Link 141 will rotate fully clockwise about axis 143 and link 142 will cause push frame 150 to increase force on the frame 153 (FIG. 6) of lowbed trailer 113 thereby raising the vertical position of gooseneck 112 and of lowbed trailer 113 attached thereto in order to allow increased clearance for the lowbed trailer 113 to move over the obstruction in the roadway. Likewise, it may be desired to reduce the height of the lowbed trailer 113 so that the load may pass beneath overhead obstructions.

During the lifting and lowering operation of the lowbed trailer 113 using the hydraulic cylinders 133, it will be noted that the force illustrated at F1 in FIG. 3C is directed axially along hydraulic cylinder 133 and piston 134 and the force F2 directed by link 142 on pushframe 150 are offset; that is, the axial force of piston 134 does not act directly on pushframe 150 but, rather, the force provided by the hydraulic cylinders 133 acts on pushframe 150 through linkage 140. Such force directional change allows the hydraulic cylinders 133 to be mounted lower in the gooseneck 112 with a smaller dimensional configuration and to thereby take a more horizontal position and allow a smaller box beam than would otherwise be the case if it was necessary to act directly on the push frame 150. Likewise, since the hydraulic cylinders 133 are mounted within the boxbeams 132 which comprise the gooseneck 112, the space 131 between the gooseneck beams 132 can be maintained without unnecessary hydraulics and associated apparatus so that the operator may use the space 131 for transport purposes.

It will be clear that a number of different linkages may be utilised to perform the function of force transmissibility between the hydraulic cylinders 133 and the push frame 153 which other linkages may still incorporate the teachings of the invention relating to force transmission and mechanical force advantage. It is contemplated that such other linkages will still be included in the scope of the present invention. Likewise, while the use of a pushframe 150 has been described and is useful, it is further contemplated that the force provided from linkage 140 may well be applied directly to the frame of the lowbed trailer 113 or through a further member.

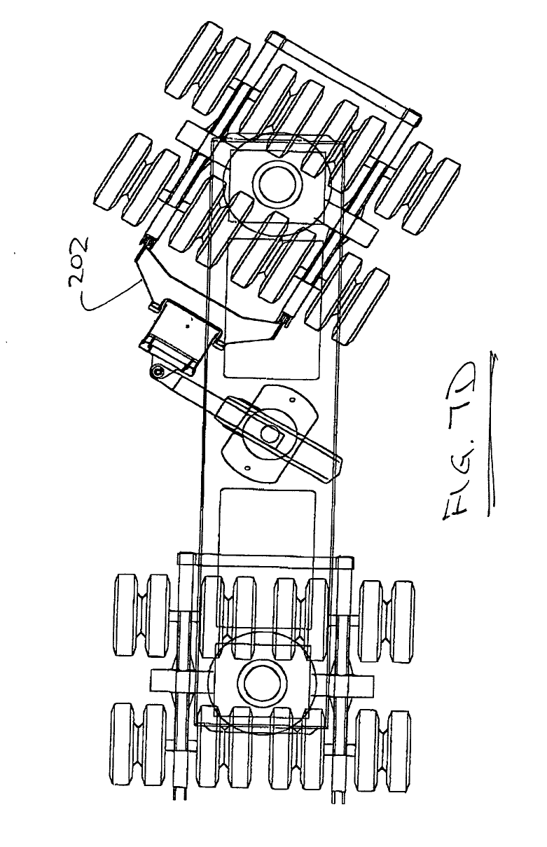

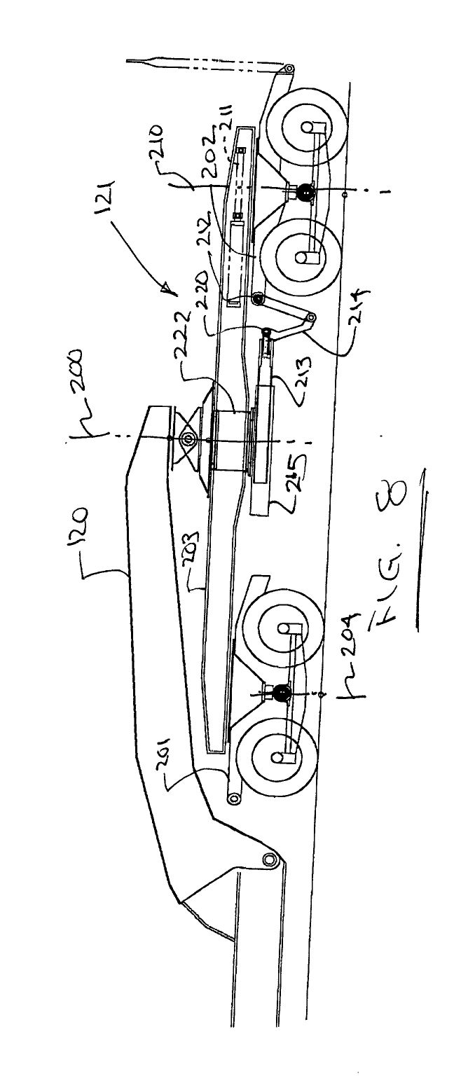

The auto steer dolly is shown generally at 121 in FIG. 1A and is illustrated in enlarged form in FIGS. 7A, 7B, 7D and 8. The dolly 121 is conveniently connected, in this instance, to a gooseneck 120 (FIG. 8). The auto steer dolly 121 is rotatable about a central articulation vertical axis 200 relative to the gooseneck 120.

A front wheel frame 201 and a rear wheel frame 202 are rotatably connected to the dolly frame 203 of the dolly 121. Front wheel frame 201 rotates about vertical front wheel frame axis 204 and rear wheel frame 202 rotates about vertical rear wheel frame axis 210, all as is known in the art.

The adjustable steer dolly 121 is both mechanically and hydraulically steerable. At low speeds, the adjustable steer dolly 121 may be steered by a hydraulic steer mechanism as exemplified by hydraulic cylinder 211 which is connected to the rear wheel frame 202 and which hydraulic cylinder 211 has a piston which is extendible and retractable relative to the hydraulic cylinder 211. The operation of the hydraulic cylinder 211 is conveniently under the control of an operator.

The wheel frame 202 is in the form of an A-frame rotating about vertical axis 210 with a forward pivot point 212. A stinger or steering arm 213 is adjustably mounted in a box 215 which steering arm 213 is extendible from box 215 thereby to increase or decrease the degree of steering provided by A-frame 202. An equaliser link 214 is provided between the forward pivot point 212 of A-frame 202 and steering arm pivot 220. The equaliser link 214 allows for the rotation of A-frame 202 and steering arm 213.

In operation, when the tractor 101 (FIG. 1A) turns around a corner or other obstacle, the auto steer dolly 121 will rotate in a counter direction tending to steer the dolly 121 to the outside of the turn being made by the trailer. The rear wheel A-frame 202 will likewise rotate relative to the dolly 121 and the box 215 will rotate about vertical articulation axis 200 with stinger or steering arm 213 extending therefrom. It will be appreciated that steering arm 21 is adjustable within box 215 and that it may be extended relative to box 215 thereby to increase the degree of steering of rear wheel A-frame 202 or it may be retracted in box 215 thereby to decrease the degree of steering of rear wheel A-frame 202. As the box 215, steering arm 213 and rear wheel A-frame 202 rotate, link 214 compensates and extends between the forward pivot point 212 of rear wheel A-frame 202 and steering arm pivot 220 of steering arm 213. When link 214 is fully extended, it will resemble the configuration illustrated in FIG. 7C thereby limiting any further rotation of rear wheel A-frame 202.

At very low speeds of tractor 101, it may be desirable to manually control the rotation and thereby the degree of steering of rear wheel A-frame 202. In this case, a disconnect mechanism 221, conveniently air driven shot pins (not illustrated) extending between box 215 and torque tube 222, disconnect the box 215 from the torque tube 222 and allow the box 215 and steering arm 213 to rotate freely of torque tube 222. A hydraulic cylinder 211 is connected to rear wheel A-frame 202 and, by extending or retracting the piston of hydraulic cylinder 211, rear wheel A-frame 202 can be rotated as desired by the operator about rear wheel frame axis 210. Provision may be made for wire or wireless transmission of the necessary commands to the cylinder 211 from the operator within tractor 101 and/or manual input to the hydraulic cylinder 211 may be provided by way of controls positioned adjacent the rear wheel A-frame 202 or hydraulic cylinder 211.

Many modifications in addition to those specifically set forth will readily occur to those skilled in the art to which the invention relates and the specific embodiments described should be taken as illustrative of the invention only and not as limiting its scope which should be defined in accordance with the accompanying claims.

I claim:

1. A hydraulically operated gooseneck for use with a lowbed trailer comprising at least one hydraulic cylinder within a beam of said gooseneck, said hydraulic cylinder applying force to a pushframe through a linkage applying force to said pushframe, said linkage applying a directional force to said pushframe which direction force is offset from the axial force applied by said hydraulic cylinder acting on said linkage.

2. Hydraulically operated gooseneck as in claim 1 wherein said pushframe is the frame of a lowbed trailer.

3. Hydraulically operated gooseneck as in claim 1 wherein said pushframe is a third member acting on said lowbed trailer.

4. Hydraulically operated gooseneck as in claim 3 wherein said hydraulic cylinder applies force to a first link in said linkage.

5. Hydraulically operated gooseneck as in claim 4 wherein said first link applies force to a second link.

6. Hydraulically operated gooseneck as in claim 5 wherein said second link applies force to said push frame.

7. Hydraulically operated gooseneck as in claim 6 wherein said hydraulic cylinders number two(2).

8. Hydraulically operated gooseneck as in claim 7 wherein each of said hydraulic cylinders is enclosed in a box frame.

9. Method of moving a gooseneck relative to the fifth wheel of a tractor or jeep comprising the steps of applying a force from a hydraulic cylinder mounted within a beam of said gooseneck to a linkage connected to a push frame associated with a lowbed trailer, said force being sufficient to move said beam of said gooseneck relative to said push frame and thereby raising or lowering said lowbed trailer, the direction of axial force applied from said hydraulic cylinder being offset from the direction of force applied to said push frame from said linkage during said raising or lowering.

10. Method of moving a gooseneck as in claim 9 wherein said push frame is a member separate from said lowbed trailer.

11. Method of moving a gooseneck as in claim 9 wherein said push frame acts upon said lowbed trailer and said beams of said gooseneck move relative to said push frame.

12. Hydraulically operated gooseneck as in claim 1 and further comprising an auto steer mechanism for steering a second set of wheels mounted beneath a dolly frame which is rotatable about a vertical axis comprising a first set of wheels having a first axis of rotation on one side of said vertical axis, said distance between said first axis and said vertical axis being constant, a second set of wheels having a second axis of rotation on the opposite side of said vertical axis, said second set of wheels being positioned on a wheel frame which is rotatable about said second axis of rotation, said wheel frame having a frame pivot point, a stinger adjustably mounted to rotate about said vertical axis and having a stinger pivot point, at least one equaliser link mounted between said frame and stinger pivot points, the distance between said stinger pivot point and said vertical axis being adjustable, said rotatable frame, said stinger and said equaliser link being located beneath said dolly frame.

13. An auto steer mechanism for steering a second set of wheels mounted beneath a dolly frame which is rotatable about a vertical axis comprising a first set of wheels having a first axis of rotation on one side of said vertical axis, said distance between said first axis and said vertical axis being constant, a second set of wheels having a second axis of rotation on the opposite side of said vertical axis, said second set of wheels being positioned on a wheel frame which is rotatable about said second axis of rotation, said wheel frame having a frame pivot point, a stinger adjustably mounted to rotate about said vertical axis and having a stinger pivot point, at least one equaliser link mounted between said frame and stinger pivot points, the distance between said stinger pivot point and said vertical axis being adjustable, said rotatable frame, said stinger and said equaliser link being located beneath said dolly frame.

14. Auto steer mechanism as in claim 13 wherein said equalizer links number two(2).

15. Method of moving a gooseneck as in claim 9 and further comprising steering a set of wheels about a vertical frame axis which wheels are mounted on a wheel frame having a frame pivot, said wheel frame being positioned beneath and rotatable relative to a dolly frame comprising the steps of allowing said wheel frame to rotate relative to said dolly frame about said vertical wheel frame axis during movement of said dolly frame relative to the rotation of said wheel frame, allowing an adjustable stinger having a stinger pivot to rotate relative to said dolly frame and allowing at least one equaliser link extending between said frame and stinger pivots to extend and contract as said wheel frame rotates relative to said dolly frame.

16. A method for steering a set of wheels about a vertical frame axis which wheels are mounted on a wheel frame having a frame pivot, said wheel frame being positioned beneath and rotatable relative to a dolly frame comprising the steps of allowing said wheel frame to rotate relative to said dolly frame about said vertical wheel frame axis during movement of said dolly frame relative to the rotation of said wheel frame, allowing an adjustable stinger having a stinger pivot to rotate relative to said dolly frame and allowing at least one equaliser link extending between said frame and stinger pivots to extend and contract as said wheel frame rotates relative to said dolly frame.
